(19) United States
(12) Patent Application Publication
(10) Pub. No.: US 2002/0141865 A1
(43) Pub. Date: Oct. 3, 2002

(54) Henke wheel

(76) Inventor: Kurt Henke, Folsom, CA (US)

Correspondence Address: Kurt Henke, 1127 Reston Dr., Folsom, CA, 95630, US

(21) Appl. No.: 09/774,420

(22) Filed: Feb. 1, 2001

(51) Int. Cl. F03D 1/02

(52) U.S. Cl. 415/202; 416/197 A

(57) ABSTRACT

Replace prior art of rotors, rotating inside a housing and are powered by forces under pressure such as fluid, air, steam and gas as used in manufacturing, power equipment, fluid and air motors with a Henke Wheel by expanding the same area exposed to force on prior art on the vane of the Henke Wheel within the same radius and establish the shortest, practical distance across the vane from the inside wall of the housing to the outside wall of the Henke Wheel to obtain the highest possible leverage to maximize the removal of energy from the input force and increase torque at least 100% over prior art whenever a Henke Wheel is used and save energy.

The Henke Wheel will offer the same benefit over prior art in the production of energy whenever used in free flowing water or hydroelectric power.

### BRIEF SUMMARY OF MY INVENTION

The Henke Wheel is a device designed to maximize the removal of energy from input forces under pressure such as fluid, air, steam and gas. This is accomplished by removing the force close to the shaft of prior art, and expanding the same area in the same radius on the vane of the Henke wheel and increase the torque at least 100% over prior art to save energy.

The Henke Wheel will not only offer an advantage over prior art in the manufacturing, power equipment, fluid and air motors, it will offer the same advantage in the energy production, utilizing free flowing water or hydro-electric power, whenever a Henke Wheel is used.

### BACKGROUND OF THE INVENTION

The present invention relates generally to turbines and motors having rotors directly attached to the axle shaft or a hub, and then slipped over the shaft. These are used in manufacturing, power equipment, fluid and air motors. More particularly, it relates to an improvement over prior art devices, pertaining to the construction of such a device designed to maximize the removal of energy from the input forces under pressure such as fluid, air, steam and gas and increase the torque at least 100% over prior art. As shown in references in U.S. CL. 415/2R field of search 415/2R 4/R U.S. Pat. No. 4,436,480 inventor, vary, dated Mar. 13, 1984 and the following patents:

| Inventor: | Patent No: | Issued: |
|---|---|---|
| Glucksman | 3,694,481 | Oct. 3, 1972 |
| Saxman | 3,883,261 | May 13, 1975 |
| Lebost | 4,295,783 | Oct. 20, 1981 |
| Pelto | 4,406,121 | Sept. 27, 1983 |
| Chang | 5,269,655 | Dec. 14, 1983 |

The rotor blades are connected closely to the axle shaft and therefore are not maximizing the removal of the energy from the input force. In my invention I do just the opposite, taking the force away close to the shaft and expanding the same area inside the same radius on the vane of the Henke Wheel and establish the shortest, practical distance between the inside wall of the housing and the outside wall of the Henke wheel, for the highest possible leverage. The Henke Wheel will now run on the same volume, pressure and turn the same RPM. But due to the high leverage, it will maximize the removal of energy from the input force and increase the torque at least 100% over prior art. I made the following test by using a 2 by 2 square inch area sheet metal, attached the same to a shaft, which I suspended by putting each end through a hole, bent the shaft at one end slightly and had it rest on an electronic postal scale working in increments of 1/10 oz. I divided the 2 square inch area into 4 equal sections. Then I placed 4^{½} inch machine nuts on section 4 and got the following value as shown in FIG. 6. After placing 4^{½} inch nuts on section 3 and section 2 and then on section 1. The chart FIG. 6 clearly indicates how sharply the torque drops from section 4 to section 1 close to the axle shaft. I then placed 16^{½} inch machine nuts on the vane of the Henke Wheel using the same area, in the same radius as section 4 FIG. 6 and increased the torque 100% over prior art. This clearly shows the advantage of the Henke Wheel. I strongly believe that by using a ^{½} inch or a ^{½} inch distance across the vane, which is still a practical distance, to provide 16 sections. The torque produced by the first section closest to the inside wall of the housing, times the total number of sections will be the total torque produced by said unit. Now the Henke Wheel will increase the torque to more than 150% over prior art. Due to the volumetric change of forces inside the housing, by moving forces from the shaft toward the inside wall of the housing it is necessary to go to at least a ^{½} inch or less distance across the vane for the Henke Wheel to run on the same volume, same pressure, and turn the same RPM, and increase torque up to more than 150%.

I want to state now that the above test is not conclusive, but when one is made the percentage numbers for each section and the torque increase as shown in FIG. 6 will be very much the same.

### BRIEF DESCRIPTION OF THE DRAWINGS

FIG. 1—Shows a side elevation view of the Henke Wheel.

FIG. 2—Is a side elevation view of the housing.

FIG. 3—Shows the side axle view of the end piece.

FIG. 4—Is showing prior art.

FIG. 5—Is showing an enlarged detail view of partial section shown on FIG. 2.

FIG. 6—Chart of test results.

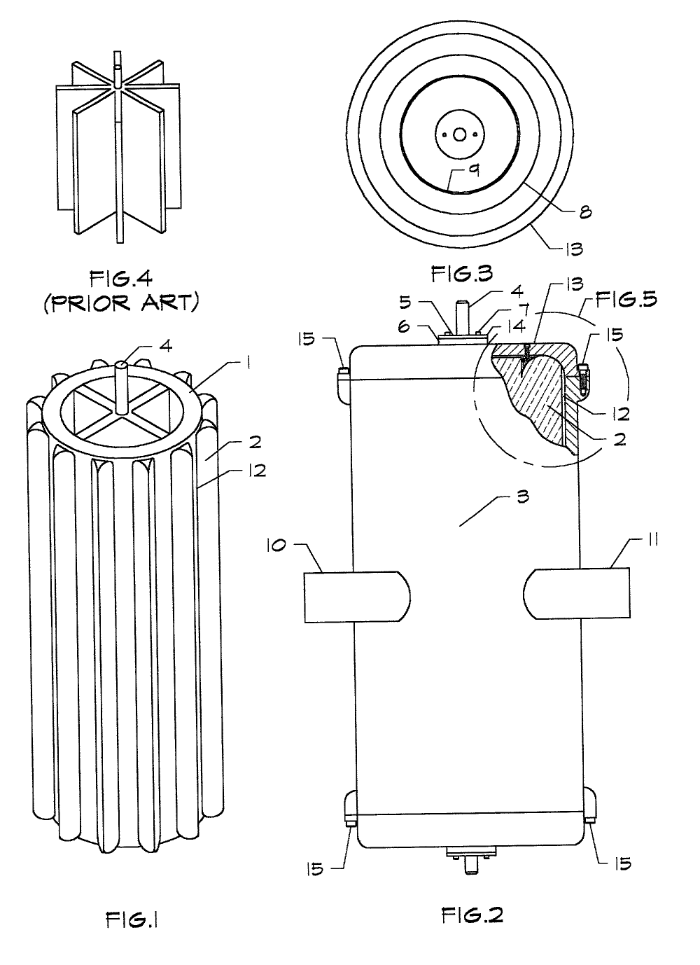

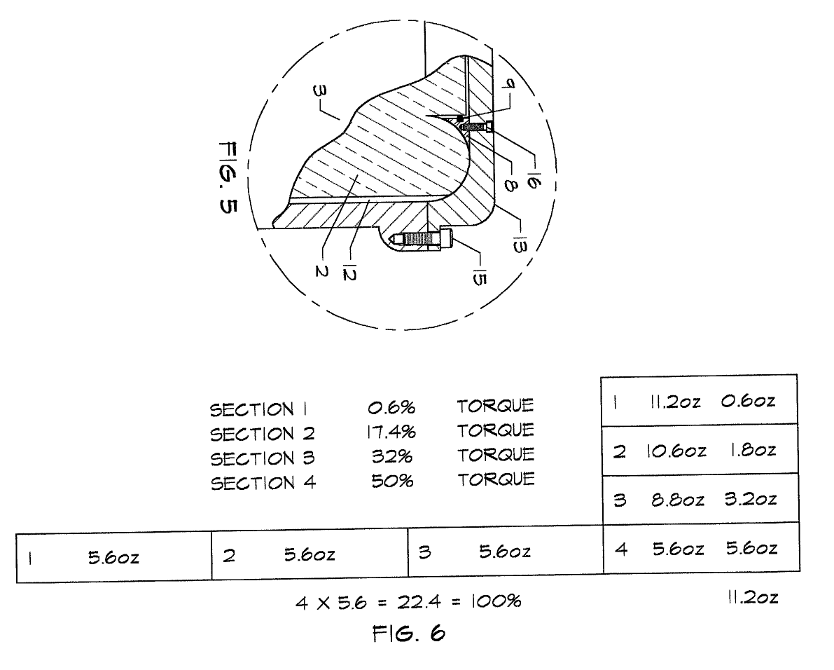

### DETAILED DESCRIPTION OF THE INVENTION

The Henke Wheel (1) made of cast iron, aluminum, or plastic depending on the application. It has a plurality of vanes, (2) rotating in an annular housing, (3) which has two identical end pieces (13). The Henke Wheel is fixed to a vertical shaft (4) turning in a bearing (5) at the top and at the bottom, which are held in place by collars (6) at the top and at the bottom. A cover plate (14), which is held in place by bolts (7) and identical end pieces, are held in place by bolts (15).

A retainer ring (8) with an arcuate side facing the inside wall of the end piece, which has an arcuate side facing the arcuate side of the retainer ring holding seal (9) for the Henke Wheel to turn within. The housing will have a suitable inlet (10) and an outlet (11) depending on the application. A seal (12) on the outer edge of the vane will provide more efficiency. The Henke Wheel will function in the vertical and horizontal position.

The object of my invention is to provide a device that will maximize the removal of energy from the input forces under pressure such as fluid, air, stream and gas by removing the force close to the shaft from prior art (4) and expanding the same area, in the same radius, on the vane of the Henke Wheel and increase torque more than 100% over prior art to save energy. I see a Henke Wheel in the size of 1 inch length and 1 inch diameter to 8 feet diameter and a length of 48 feet.

What I claim in my invention is:

1. The Henke Wheel operating with forces such as fluid, air, steam and gas. Having vanes with a chosen or the shortest practical distance between the inside wall of the housing and the outside wall of the Henke Wheel to provide the highest leverage to the input force to maximize the removal of energy to increase torque at least 100% over prior art.
a) A seal on the outer edge of the vane for efficiency.

2. A device in accordance with claim 1.
Having two identical end pieces attached to the housing, both having an arcuate side, facing the arcuate side of the retainer ring.

3. A device in accordance with claim 2.
Having a retainer ring with an arcuate side, facing the arcuate side of the identical end piece, which is holding a seal for the Henke Wheel to turn within.
